(19) United States
(12) Patent Application Publication
(10) Pub. No.: US 2018/0108521 A1
(43) Pub. Date: Apr. 19, 2018

(54) Method of Increasing Quality of Tandem Mass Spectra

(71) Applicant: DH Technologies Development Pte Ltd., Singapore (SG)

(72) Inventor: John L. Campbell, Milton (CA)

(21) Appl. No.: 15/556,698

(22) PCT Filed: Mar. 8, 2016
(86) PCT No.: PCT/IB2016/051312

§ 371 Date: Sep. 8, 2017

Related U.S. Application Data
(60) Provisional application No. 62/131,287, filed on Mar. 11, 2015.

(51) Int. Cl. H01J 49/00; G01N 30/72; G01N 30/86; H01J 49/42

(52) U.S. Cl. CPC H01J 49/0081; G01N 30/7233; H01J 49/4265; G01N 30/8644; H01J 49/0036; G01N 30/8631

(57) ABSTRACT

A method and apparatus for improving the quality of spectra of a sample obtained from a tandem mass spectrometer system containing an ion trap. The method and apparatus includes the setting of an upper and lower threshold limit on peak intensity and only triggering an enhanced product ion scan when a detected intensity of a peak in an initial scan falls between the upper and lower threshold limits. The spectra obtained from an enhanced product ion scan conducted in this manner are useful in library matching of spectra. The ion trap may be a linear ion trap and the sample may be a peptide.

### RELATED APPLICATIONS

This application claims the benefit of priority from U.S. Provisional Application Ser. No. 62/131,287, filed on Mar. 11, 2015, the entire contents of which are hereby incorporated by reference.

### FIELD

The within teachings are directed to methods relating to mass spectrometry and increasing the quality of mass spectra that are utilized for library searching and matching.

### BACKGROUND

In mass spectrometry analysis, both quantitative and qualitative analysis of analytes can be produced. For an unknown sample, the identification of a particular analyte is informative. This step is performed in some cases by conducting searches of obtained spectra with that of previously obtained mass spectra commonly found in mass spectra libraries or databases.

Matching of unknown spectra with those contained within a library is not always exact and relies on the quality of the spectra of the unknown sample and that of the spectra contained within the library.

Unknown sample mass spectra are often obtained via tandem mass spectrometry (MS/MS or MS²) where multiple individual mass spectrometer stages are utilized to manipulate and/or transfer ions. This type of setup allows Multiple Reaction Monitoring (MRM) experiments to be performed in which a first mass spectrometer (commonly referred to as Q1) isolates a selected precursor based on m/z ratio (i.e., a transition) and that precursor is transferred to a second mass spectrometer (Q2) that functions as a collision cell to induce fragmentation of the precursor. The fragmented product ions are then passed through to a third mass spectrometer unit where they can be further filtered (as is the case with MRM), analyzed, or manipulated. A common MRM-based workflow is in an Information Dependent Acquisition (IDA) in which an initial full scan is performed in Q1 by stepping through increasing m/z windows and only the most intense peaks or peaks exhibiting a certain minimum threshold intensity are then selected for an Enhanced Product Ion (EPI) scan where ions are selected in Q1, fragmented in Q2, and trapped in an ion trap and then individual fragment ions are scanned out of the trap and detected providing a detailed spectrum. In other embodiments, the specific transitions that are desired to be utilized are already known. In such cases, the IDA based analysis can be setup to monitor for only specific transitions and trigger the specific EPI scan only when certain minimum thresholds are met.

In ion trapping systems with these types of workflow, resulting EPI spectra are sometimes inadequate for the purpose of library matching and are of low quality. As an example, exhibited peaks may have shifted m/z values, or demonstrate signs of peak splitting and low intensity which are traits that ultimately lead to prevention of proper comparisons with spectral libraries.

It has been found that these phenomena are primarily due to the deleterious effects of high space charge in the trap that sometimes form as a result of a large presence of ions. Accordingly a manner in how to perform an MRM-IDA-EPI scan in these situations is required.

### SUMMARY

According to some aspects of the present teachings, a method of performing an analysis is disclosed which includes: separating a sample in a liquid chromatography column to form sample components; receiving in a tandem mass spectrometer, ions of said sample components; monitoring predetermined transitions in said tandem mass spectrometer and receiving intensity data of said ions as a function of column retention time; defining a minimum and maximum threshold intensity; triggering said tandem mass spectrometer to perform an enhanced product ion scan when said intensity exceeds said minimum threshold intensity and is less than said maximum threshold intensity and wherein said enhanced product ion scan comprises selecting ions in a first mass spectrometer; fragmenting said selected ions in a collision cell to form fragment ions; collecting said fragment ions in a trapping mass spectrometer and scanning out individual fragment ions at increasing m/z ratio from said ion trapping mass spectrometer and detecting the fragment ions with a detector.

In some embodiments, the trapping mass spectrometer is a linear ion trap. In some embodiments, the first mass spectrometer and the trapping mass spectrometer each comprises a quadrupole. In some embodiments, the sample is a peptide sample. In some embodiments, the maximum threshold intensity is determined based on a saturation limit of said detector. In some embodiments, the detecting of fragment ions is utilized to generate a mass spectra. In preferred embodiments, the mass spectra generated is compared to a database of previously obtained mass spectra.

According to some aspects of the present teachings, a method of performing analysis of a sample is disclosed, the method including: eluting the sample through a liquid chromatography column to form an elutant thereof; ionizing components of the elutant to form ions; performing a scan of said ions in a first mass spectrometer to obtain intensity data as a function of column retention time; comparing an intensity at a given point of time obtained from said scan to a lower threshold intensity and an upper threshold intensity and when the intensity is lower than the lower threshold intensity or is higher than the threshold intensity, waiting a predetermined amount of time and repeating this step; performing an enhanced product ion scan in a trapping mass spectrometer when the intensity is higher than the lower threshold intensity and is lower than the upper threshold intensity and wherein said enhanced product ion scan comprises selecting ions in the first mass spectrometer, fragmenting said selected ions in a collision cell to form fragment ions, collecting said fragment ions in a trapping mass spectrometer and scanning out individual fragment ions at increasing m/z ratio from said ion trapping mass spectrometer and detecting the fragment ions with a detector.

In some embodiments, the predetermined amount of time is 1 second. In some embodiments, the trapping mass spectrometer is a linear ion trap. In some embodiments, the first mass spectrometer and the trapping mass spectrometer each comprises a quadrupole. In some embodiments, the sample is a peptide sample. In some embodiments, the maximum threshold intensity is determined based on a saturation limit of the detector. In some embodiments, the detecting of fragment ions is utilized to generate a mass spectra. In further embodiments, a comparison is made of the mass spectra to a database of mass spectra. In further embodiments, one or both of said ions or fragment ions is identified based on the comparison.

According to some aspects of the present teachings, a tandem mass spectrometer system is disclosure, which comprises: a liquid chromatography column; a first mass spectrometer in fluid communication with an output of the liquid chromatograph column; a collision cell in fluid communication with said first mass spectrometer; a second mass spectrometer in fluid communication with said collision cell, said second mass spectrometer comprising a trapping mass spectrometer; a data processor operably connected to each of the first and second mass spectrometers, and collision cell to control operation thereof; said data processor configured to: monitor an intensity peak obtained from either the first or second mass spectrometer when a sample is being analyzed as a function of column retention time, compare said intensity peak to a lower threshold value and a higher threshold value, triggering said tandem mass spectrometer system to perform an Enhanced Product Ion scan of the sample when said intensity peak exceeds the lower threshold value, but is less than the higher threshold value and wherein said enhanced product ion scan comprises selecting ions in the first mass spectrometer, fragmenting said selected ions in the collision cell to form fragment ions, collecting said fragment ions in the trapping mass spectrometer and scanning out individual fragment ions at increasing m/z ratio from said ion trapping mass spectrometer and detecting the fragment ions with a detector.

In some embodiments, the trapping mass spectrometer is a linear ion trap. In some embodiments, the first mass spectrometer and said trapping mass spectrometer each comprises a quadrupole. In some embodiments, the maximum threshold intensity is determined based on a saturation limit of said detector.

### BRIEF DESCRIPTION OF FIGURES

FIG. 1 depicts the MRM intensity of ionized analyte measured at differing concentrations as a function of the liquid chromatography (LC) retention time of the analyte.

FIG. 2 depicts FIT scores for various concentrations at various LC retention times

FIG. 3 depicts PURITY scores for various concentrations at various LC retention times

FIG. 4 depicts an example of the triggering of an EPI scan according to one embodiment of the invention

FIG. 5 depicts an example of setting of the upper and lower thresholds according to an embodiment of the invention.

FIG. 6 is a block diagram that illustrates a computer system, upon which embodiments of the present teachings may be implemented.

### DETAILED DESCRIPTION OF EMBODIMENTS

The within teachings are generally directed to mass spectrometers that operate to analyze ions that are formed upon ionizing a sample. More particularly, the within teachings are directed to tandem mass spectrometer systems that comprise an ion trapping mass spectrometer. In some embodiments, the tandem mass spectrometer can be connected in series to other devices commonly used with mass spectrometer systems such as liquid chromatography devices, Electron Capture Dissociation Devices, Field Asymmetric Ion Mobility Devices, Differential Mobility Spectrometers, etc. The use of a liquid chromatography column is particularly preferred in one embodiment of the within teachings.

Liquid chromatography (LC) provides a method in which separation can be performed. Samples are typically injected into a liquid chromatography column and depending on the solvents utilized, different degrees of separation of the components occur as the sample elute through the column. The time at which a particular component of sample exits the column is referred to as a retention time.

Ionizing of samples to form ions can be performed by methods which are known in the art which include the use of electrospray, and Matrix assisted laser desorption and ionization (MALDI), amongst other techniques.

Tandem mass spectrometer devices are useful in performing MRM analysis. In an IDA-based workflow, information and data from an initial scan performed in Q1 is utilized to determine what additional experiments should be performed. More particularly, the initial scan provides a series of intensities at increasing m/z ratios or time and the ratios or times having the most intense peaks are then utilized as “transitions” in subsequent MRM based experiments. These transitions can then be selected in Q1 by operating Q1 as a filter and fragmenting the selected ions in a collision cell and then analyzing the fragment product ions in a mass spectrometer. An Enhanced Product Ion Scan is when this last step is performed in a trapping mass spectrometer where the fragment ions are collected in the trap and then individual ions at specific m/z ratios are scanned out (i.e., removed) from the trap one at a time and detected.

It has been found that by setting an MRM intensity upper ceiling trigger value in Q1, in combination with the conventional lower floor level for triggering an Enhanced Product Ion Scan, that higher quality EPI spectra are collected. This in turn leads to library search results that are of higher quality and are of higher confidence.

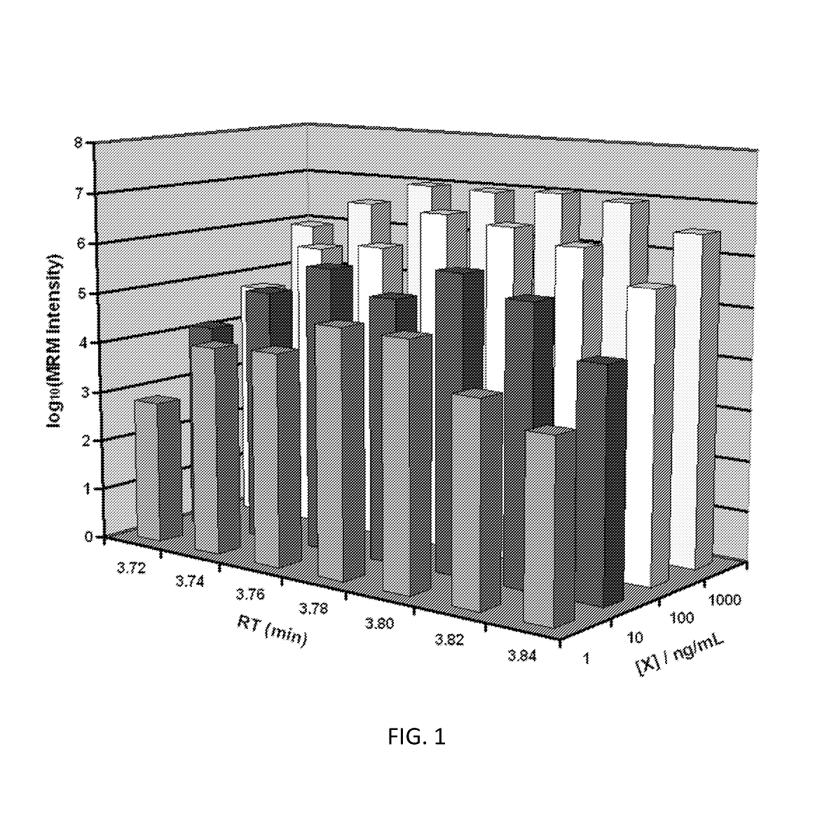

Shown in FIG. 1 is a plot of various ions measured in a trapping mass spectrometer at varying concentrations. At a concentrations of 1 ng/mL, the profile of the intensities over the RT range measured is approximately of a Gaussian distribution. As the concentration is increased, an increasing intensity is also seen, but reaches an intensity limit which corresponds to the saturation limit of the detector. For example, at the 1000 ng/mL level, four of the ions in the plot have the same intensity measurement.

When these peaks are utilized to generate an EPI scan, the resulting matching of spectra is imprecise at levels with higher initial intensity. Various ways of matching of spectra are known, one method that is utilized and available within software available from Sciex involves the FIT and PURITY metrics contained within those software package.

The FIT metric is a measure of how well a library spectrum matches the unknown spectrum. It does not take into account any peaks that are present in the unknown spectrum but are absent in the library spectrum. This allows for the possibility that the unknown spectrum is from a sample being measured that may represent an impure mixture of components. The range of scores is between 0 and 100%, with 100% representing a perfect score. It is also possible to determine a Reverse FIT metric which is a measure of how well the unknown spectrum matches a library spectrum. It does not take into account those peaks present in the library spectrum but that are absent in the unknown spectrum.

PURITY measurements attempt to measure how well the unknown spectrum matches a library spectrum. All peaks from both spectra are used and compared. The PURITY measurement ranges from 0 to 100%. High values indicate a higher likelihood that the unknown spectrum has been correctly identified and that the unknown spectrum does not contain peaks from additional compounds at a significant amount. Lower values indicate that either the match is less certain or that additional fragment ion peaks from another compound are present in the unknown spectrum or library spectrum.

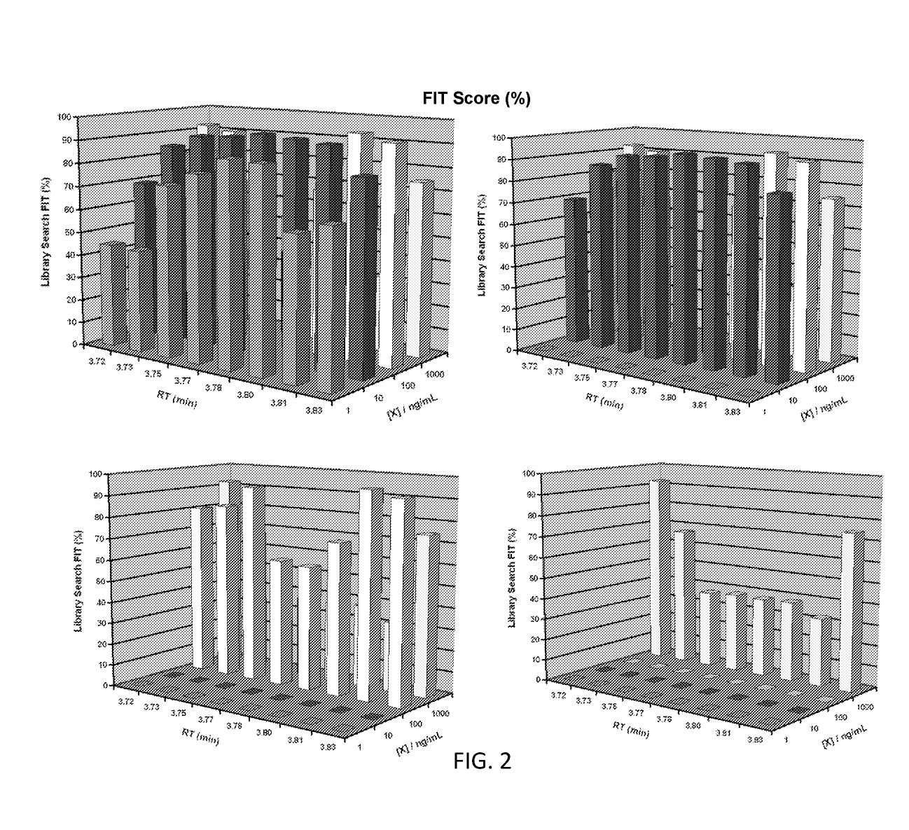

FIG. 2 demonstrates a series of FIT score plots for the primary (i.e., most intense) MRM data from FIG. 1. Only the 10 and 100 ng/mL concentrations provide FIT scores that are over 50%. At the 1000 ng/mL concentration, most of the resulting spectra are below a 40% threshold.

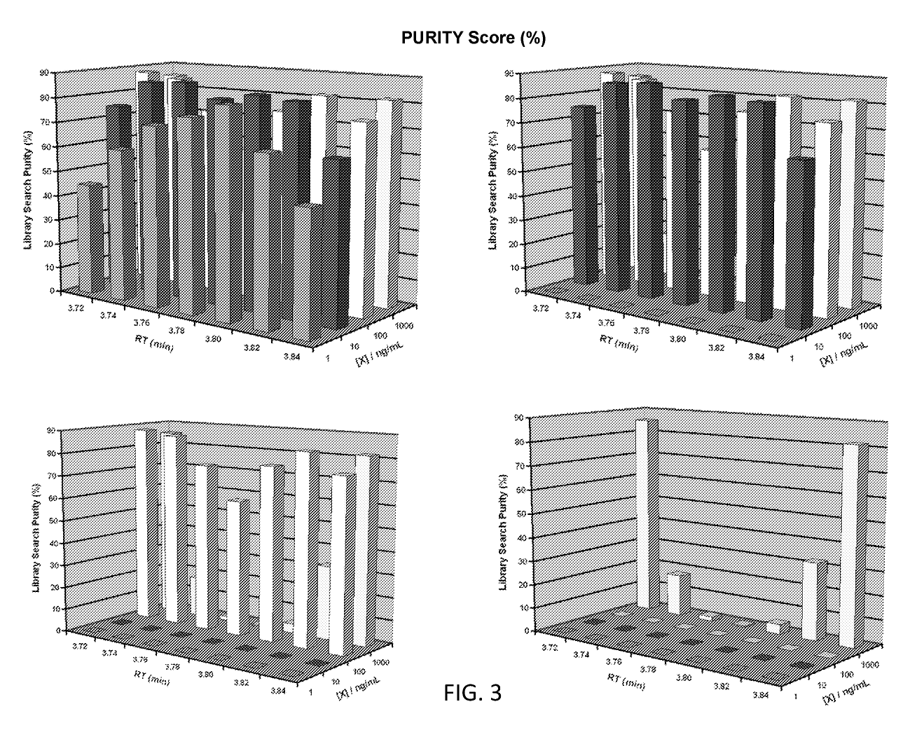

FIG. 3 demonstrates a series of PURITY score plots for the primary (i.e., most intense) MRM data from FIG. 1. The 10 and 100 ng/mL concentrations provide PURITY scores that are above 50%, whereas the 1 and 1000 ng/mL do not. The 1000 ng/mL is particularly poor providing PURITY scores of less than 5% for several of the MRM's.

It has been found that the method of identifying the optimum peak that relies on finding the most intense area of the peak that is present are less then optimum in conditions when the detector is saturated as resulting EPI scans have been found to have very poor PURITY and FIT scores. Instead, it has been discovered that rather than rely on the most intense part of the peak to center and trigger an EPI scan on, that more reliable spectra result if an upper ceiling on the intensity threshold is also enforced. That is, a given intensity measurement must exceed a floor threshold, but not exceed a ceiling threshold intensity in order for an EPI scan to be triggered. This resulting EPI scan may not be situated in the ideal retention time or m/z position, but the gain in benefit from not having a saturated detector has been found to exceed any impreciseness relating to the MRM transition being considered.

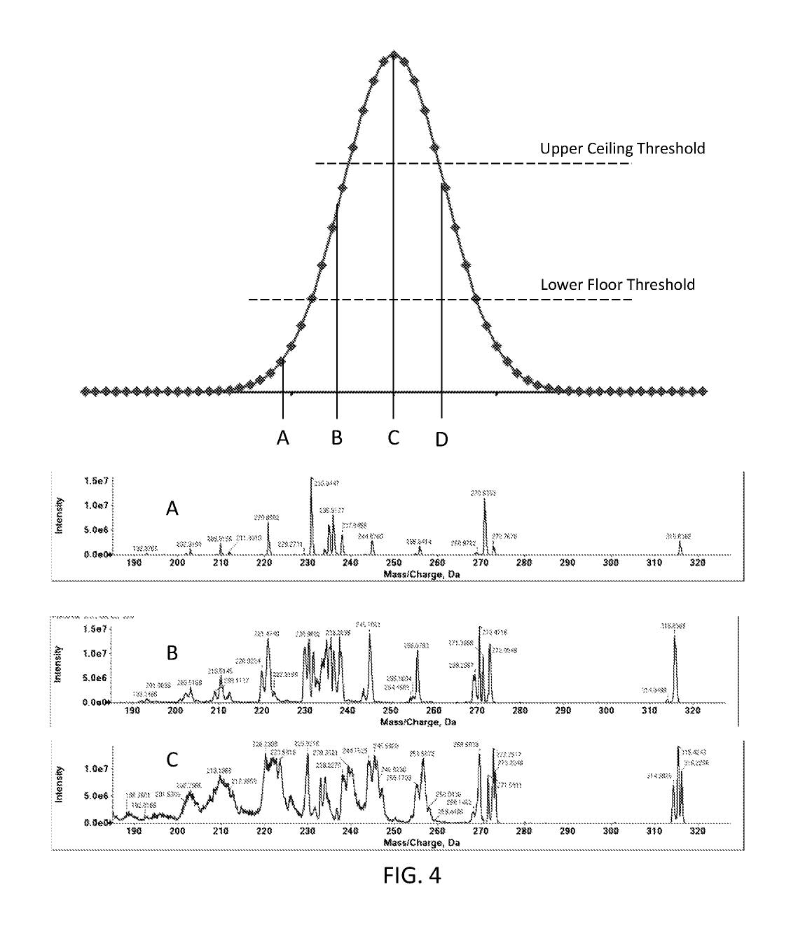

This is demonstrated in FIG. 4 where a single peak is displayed from a conventional EPI scan. The mass spectrometer system and/or controller is configured to implement only an enhanced product ion scan when the measured intensity both exceeds a floor (lower) threshold and is lower than a ceiling (higher) threshold. FIG. 4 depicts four times (A, B, C and D) wherein an EPI scan can be triggered on the mass spectrum peak. The point B falls within the desired upper and lower threshold values. Prior to the within teachings, an EPI scan would have been conducted at point C which is the apex of the peak and represents the most intense part of the peak. While this would result in an acceptable performance if the detector was not saturated, in cases where the detector is saturated, resulting spectra may contain broad undefined peaks that may be difficult to match with existing library spectra as can be seen for example in the spectra depicted for C. An EPI scan conducted at point A in FIG. 4 suffers from the opposite problem in that there may be insufficient intensity in select peaks (or they may be completely absent) to trigger a proper match from a library. However, the EPI scan performed at B provides both an adequate number of peaks and intensity to provide for an accurate library analysis even though the EPI scan is not triggered at the retention time when the analyte is at its maximum intensity (i.e., point C). While this has been particularly exemplified at point B on the increasing slope of the curve, it should be appreciated that the same type of analysis can be performed and the appropriate window of upper and lower threshold can also be satisfied on the portion of the curve after the apex, having decreasing slope as for example point D of FIG. 4.

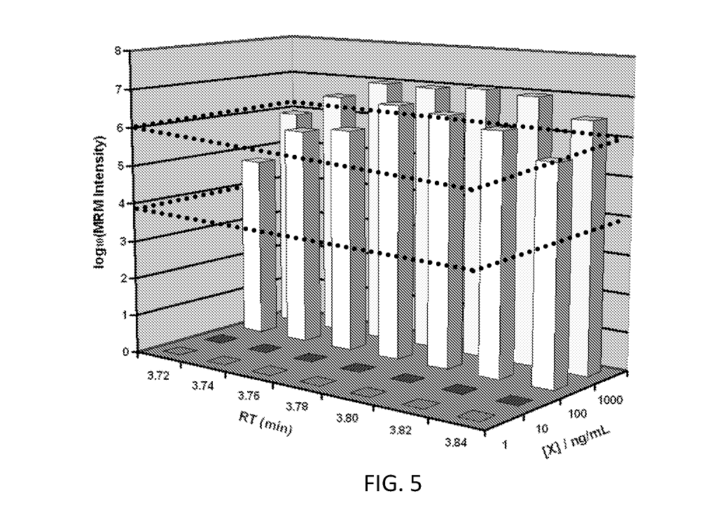

These threshold values both lower and upper can be determined through previous experiments or can be performed in real time. For example, FIG. 1 demonstrates that a saturation of the detector occurs at higher concentrations where the intensity level reaches a plateau of approximately 7. By implementing a high threshold of 6 and a lower threshold of 4 as depicted in FIG. 5, the triggering of an EPI scan would only occur at MRM transitions where higher FIT and PURITY scores would be obtained. In some cases, the higher threshold value can be determined based on knowledge of the saturation detection limit of any detectors that are utilized.

In practice, upon sampling, if an MRM is deemed to have an inadequate intensity trigger level (i.e., it is either too high or too low), a short delay time would be invoked. This delay time could be any arbitrarily defined time period, and can be tailored to match the peak widths delivered by a specific LC system. For faster chromatography, these delay times could be 1 second, but for slower chromatography, several seconds could serve as an adequate delay time. Shorter time periods would result in greater resolution, at the expense of lower duty cycle. Once this delay time passes, the information dependent acquisition would again survey the MRM for potential triggering of an EPI. This step could be repeated several times until the MRM intensity criteria satisfied the desired window of values.

Once this data has been obtained, the spectra can then be compared to existing library spectra to see if a suitable match can be obtained.

The within described teachings are best utilized in a trapping mass spectrometer. In preferred embodiments, the trapping mass spectrometer is located at Q3 of a tandem mass spectrometer. Examples of such trapping spectrometers include linear ion trap based mass spectrometers. Particularly preferred are the QTRAP® brand of quadrupole mass spectrometer systems available from Sciex.

In some embodiments, the mass spectrometer system of the within teachings comprise multiple quadrupole devices and in preferred embodiments, the mass spectrometer system comprises a triple quadrupole based device.

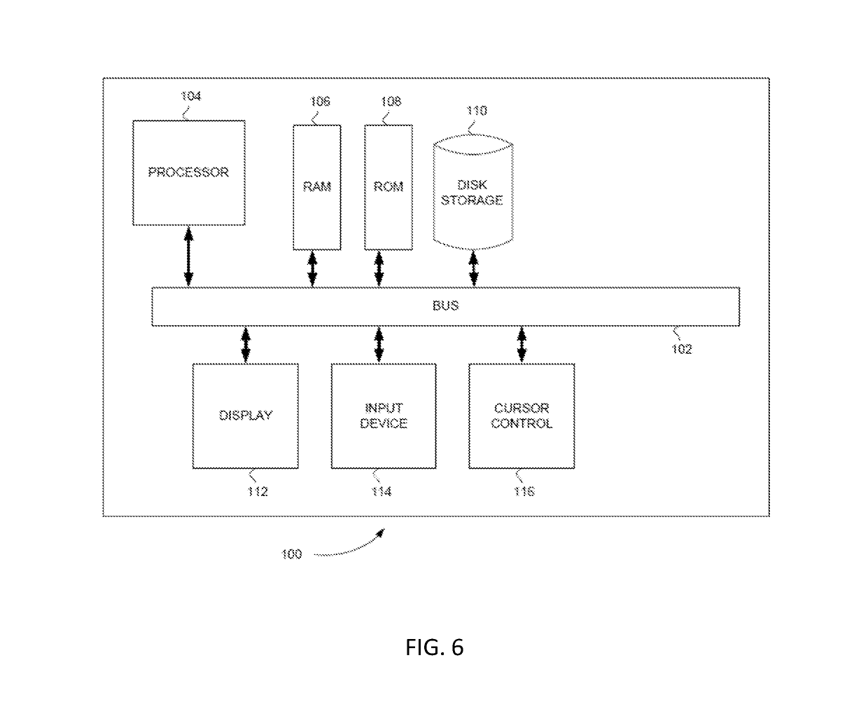

FIG. 6 is a block diagram that illustrates a computer system 100, upon which embodiments of the present teachings may be implemented. Computer system 100 includes a bus 102 or other communication mechanism for communicating information, and a data processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium.

The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The computer system and/or parts thereof are configured to communicate and transfer information between itself and various parts of the embodiments presently described. For example, the computer system can operate and receive and/or receive data from any of or various combinations of the first and second mass spectrometers, collision cell, liquid chromatograph column and/or other parts herein described or would be expected to be used in accordance with the knowledge of persons of ordinary skill.

The included descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

The invention described within the within teachings is not limited solely to the embodiments described above, but instead many variations are possible within the scope of the inventive concept defined by the claims below.

1. A method of performing an analysis, the method comprising:
separating a sample in a liquid chromatography column to form sample components,
receiving in a tandem mass spectrometer, ions of said sample components,
monitoring predetermined transitions in said tandem mass spectrometer and receiving intensity data of said ions as a function of column retention time,
defining a minimum and maximum threshold intensity,
triggering said tandem mass spectrometer to perform an enhanced product ion scan when said intensity exceeds said minimum threshold intensity and is less than said maximum threshold intensity,
wherein said enhanced product ion scan comprises selecting ions in a first mass spectrometer, fragmenting said selected ions in a collision cell to form fragment ions, collecting said fragment ions in a trapping mass spectrometer and scanning out individual fragment ions at increasing m/z ratio from said ion trapping mass spectrometer and detecting the fragment ions with a detector.

2. The method of claim 1 wherein said trapping mass spectrometer is a linear ion trap.

3. The method of claim 1 wherein said first mass spectrometer and said trapping mass spectrometer each comprises a quadrupole.

4. The method of claim 1 wherein said sample is a peptide sample.

5. The method of claim 1 wherein said maximum threshold intensity is determined based on a saturation limit of said detector.

6. The method of claim 1 wherein said detecting of fragment ions is utilized to generate a mass spectra.

7. The method of claim 6 wherein said mass spectra is compared to a database of previously obtained mass spectra.

8. A method of performing analysis of a sample, the method comprising:
eluting said sample through a liquid chromatography column to form an elutant thereof,
ionizing components of the elutant to form ions,
performing a scan of said ions in a first mass spectrometer to obtain intensity data as a function of column retention time,
comparing an intensity at a given point of time obtained from said scan to a lower threshold intensity and an upper threshold intensity and when the intensity is lower than the lower threshold intensity or is higher than the upper threshold intensity, waiting a predetermined amount of time and repeating this step;
performing an enhanced product ion scan in a trapping mass spectrometer when the intensity is higher than the lower threshold intensity and is lower than the upper threshold intensity,
wherein said enhanced product ion scan comprises selecting ions in the first mass spectrometer, fragmenting said selected ions in a collision cell to form fragment ions, collecting said fragment ions in a trapping mass spectrometer and scanning out individual fragment ions at increasing m/z ratio from said ion trapping mass spectrometer and detecting the fragment ions with a detector.

9. The method of claim 8 wherein the predetermined amount of time is 1 second.

10. The method of claim 8 wherein said trapping mass spectrometer is a linear ion trap.

11. The method of claim 8 wherein said first mass spectrometer and said trapping mass spectrometer each comprises a quadrupole.

12. The method of claim 8 wherein said sample is a peptide sample.

13. The method of claim 8 wherein said maximum threshold intensity is determined based on a saturation limit of said detector.

14. The method of claim 8 wherein said detecting of fragment ions is utilized to generate a mass spectra.

15. The method of claim 14 wherein a comparison is made of said mass spectra to a database of mass spectra.

16. The method of claim 15 wherein one or both of said ions or fragment ions is identified based on said comparison.

17. A tandem mass spectrometer system comprising
a liquid chromatography column,
a first mass spectrometer in fluid communication with an output of the liquid chromatograph column
a collision cell in fluid communication with said first mass spectrometer
a second mass spectrometer in fluid communication with said collision cell, said second mass spectrometer comprising a trapping mass spectrometer.
a data processor operably connected to each of the first and second mass spectrometers, and collision cell to control operation thereof, said data processor configured to:
monitor an intensity peak obtained from either the first or second mass spectrometer when a sample is being analyzed as a function of column retention time
compare said intensity peak to a lower threshold value and a higher threshold value
triggering said tandem mass spectrometer system to perform an Enhanced Product Ion scan of the sample when said intensity peak exceeds the lower threshold value, but is less than the higher threshold value,
wherein said enhanced product ion scan comprises selecting ions in the first mass spectrometer, fragmenting said selected ions in the collision cell to form fragment ions, collecting said fragment ions in the trapping mass spectrometer and scanning out individual fragment ions at increasing m/z ratio from said ion trapping mass spectrometer and detecting the fragment ions with a detector.

18. The system of claim 17 wherein, said trapping mass spectrometer is a linear ion trap.

19. The method of claim 17 wherein said first mass spectrometer and said trapping mass spectrometer each comprises a quadrupole.

20. The method of claim 17 wherein said maximum threshold intensity is determined based on a saturation limit of said detector.
